(19) United States
(12) Patent Application Publication
(10) Pub. No.: US 2015/0262495 A1
(43) Pub. Date: Sep. 17, 2015

(54) PORTABLE FIRE ALARM SIMULATOR / TRAINING CART

(71) Applicant: Raymond J. BRISSETTE, JR., Virginia Beach, VA (US)

(72) Inventor: Raymond J. BRISSETTE, JR., Virginia Beach, VA (US)

(21) Appl. No.: 14/500,983

(22) Filed: Sep. 29, 2014

Related U.S. Application Data
(60) Provisional application No. 61/883,556, filed on Sep. 27, 2013.

(51) Int. Cl. G09B 5/06; G09B 19/00

(52) U.S. Cl. CPC G09B 5/06; G09B 19/00

(57) ABSTRACT

A training device for instructing personnel on the functioning of emergency notification devices used in buildings such as hospitals and schools. The device includes a vertical display placed on a portable cart which preferably is on wheels. The emergency notification devices may include a fire alarm, a strobe light, a gas valve, a fire bell, an elevator simulator, a smoke detector, a fire panel or a fire door. The training device enables personnel to experience the emergency notification devices prior to an emergency.

### CROSS REFERENCE TO RELATED APPLICATION

This Application claims the benefit of U.S. Provisional Application No. 61/883,556 filed on Sep. 27, 2013 for “PORTABLE FIRE ALARM SIMULATOR/TRAINING CART,” incorporated herein by reference in its entirety.

### BACKGROUND OF THE INVENTION

1. Field of the Invention

This invention relates generally to a training simulator, and more specifically to a portable cart for simulating emergency situations.

2. Description of Related Art

Most buildings are equipped with emergency notification devices such as fire alarms, smoke alarms, etc. While such devices are commonplace, use of these devices in an emergency is fortunately not as common. In the rare situations when emergency notifications are utilized in order to protect occupants of the buildings, such use can cause panic or chaos. While simulation training can occur in which these notifications are made by voice, it would be much more effective if the building occupants, particularly those responsible for the safety of others, can see and hear the emergency notification devices in operation through simulation training.

Additionally, it is difficult, or impossible to make use of actual emergency notification devices installed in a building. For example, if smoke is used to force a smoke detector to sound its alarm, the smoke itself is noxious and could be problematic. Further, if an occupant is unaware that the smoke detector alarm is being set off intentionally, there could be panic.

It is an object of the invention to provide a training simulator for emergency situations.

It is another object of the invention to provide a training simulator for emergency situations which is portable.

It is yet another object of this invention to provide a training simulator for emergency situations which includes simulation devices for multiple emergency situations.

Finally, it is an object of the present invention to accomplish the foregoing objectives in a simple and cost effective manner.

The above and further objects, details and advantages of the invention will become apparent from the following detailed description, when read in conjunction with the accompanying drawings.

### SUMMARY OF THE INVENTION

The present invention addresses these needs by providing a training device having a portable display for displaying a plurality of emergency notification devices, a power supply for providing power to the plurality of emergency notification devices; and a cart for transporting the portable display for instructional purposes. The emergency notification devices may be a fire alarm, a strobe light, a gas valve, a fire bell, an elevator simulator, a smoke detector, a fire panel or a fire door. In a preferred embodiment, the fire alarm controls at least one of the plurality of emergency notification devices, such that when it is operated during an instruction session, the emergency notification devices that would be set off by operating the fire alarm, would be operated on the portable display, thus giving personnel a true representation of the emergency notification devices in action. The cart includes a plurality of legs, which preferably include wheels attached to each leg such that the cart may be rolled across a surface.

### BRIEF DESCRIPTION OF THE DRAWINGS

A more complete description of the subject matter of the present invention and the advantages thereof, can be achieved by reference to the following detailed description by which reference is made to the accompanying drawings in which:

FIG. 1 is a front view of the preferred embodiment of this invention;

FIG. 2 is a perspective view of a cart that may be used with the preferred embodiment of the invention; and

FIG. 3 is a perspective view of a cart that may be used with the preferred embodiment of the invention.

### ELEMENT LIST

10 cart
11 vertical display
12 cart surface
14 cart leg
16 cart wheel
18 fire alarm
20 strobe light
22 gas valve
24 fire bell
26 elevator simulator
28 smoke detector
30 fire panel
32 fire door
34 power cord

### DETAILED DESCRIPTION OF THE PREFERRED EMBODIMENT

The following detailed description is of the best presently contemplated mode of carrying out the invention. This description is not to be taken in a limiting sense, but is made merely for the purpose of illustrating general principles of embodiments of the invention. The embodiments of the invention and the various features and advantageous details thereof are more fully explained with reference to the non-limiting embodiments and examples that are described and/or illustrated in the accompanying drawings and set forth in the following description. It should be noted that the features illustrated in the drawings are not necessarily drawn to scale, and the features of one embodiment may be employed with the other embodiments as the skilled artisan recognizes, even if not explicitly stated herein. Descriptions of well-known components and techniques may be omitted to avoid obscuring the invention. The examples used herein are intended merely to facilitate an understanding of ways in which the invention may be practiced and to further enable those skilled in the art to practice the invention. Accordingly, the examples and embodiments set forth herein should not be construed as limiting the scope of the invention, which is defined by the appended claims. Moreover, it is noted that like reference numerals represent similar parts throughout the several views of the drawings.

A portable cart 10 is provided which includes emergency notification devices. The cart 10 is made from any durable material commonly used for carts which transport items. The cart is preferably on wheels to facilitate movement from one location to another. The cart 10 preferably includes a vertical display support system 11 upon which the emergency notification devices are mounted for display and use during training.

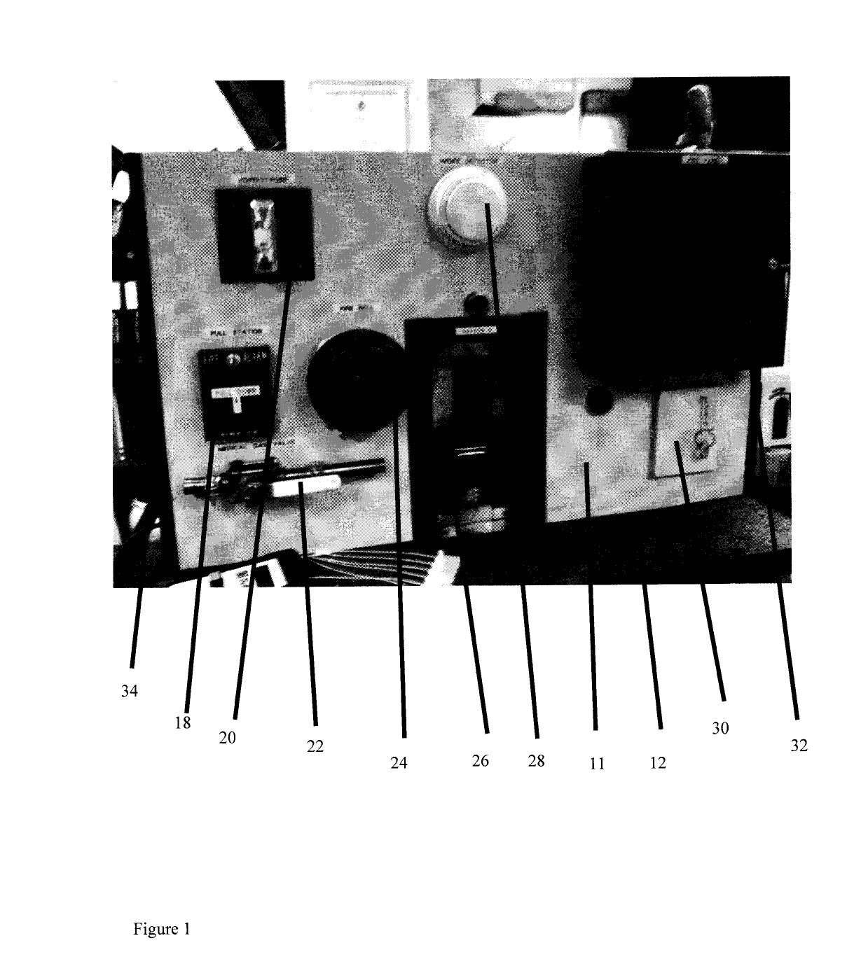

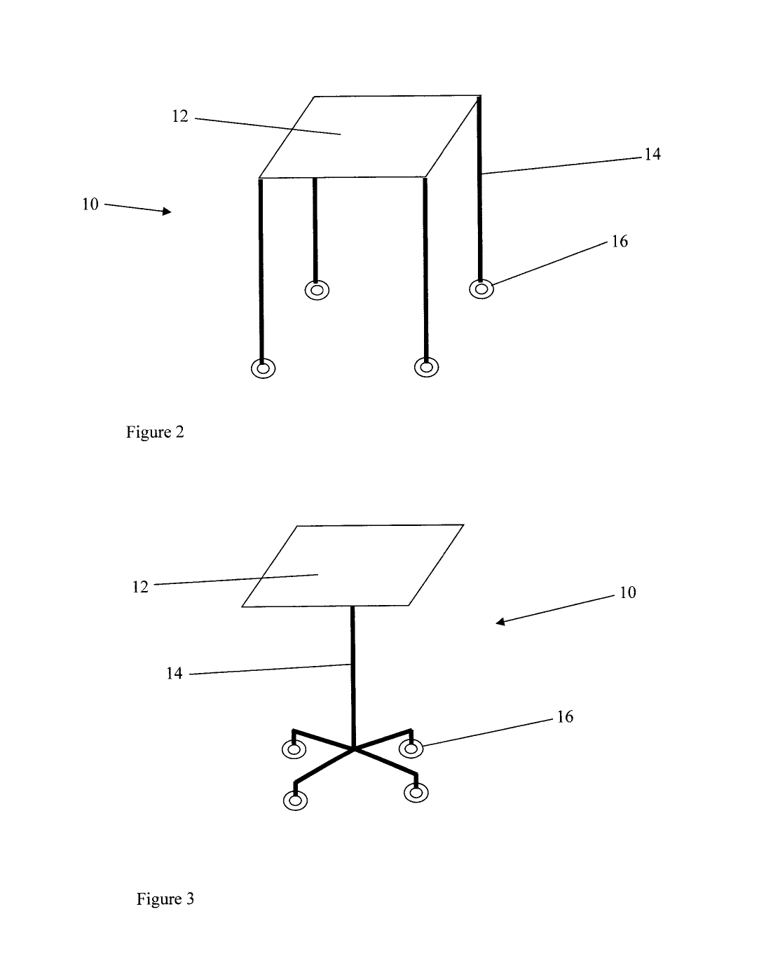

Referring to FIGS. 1, 2, and 3, a portable emergency notification device cart 10 is configured to be stable, preferably compact (so that it can be stored in a very small space), and easy and safe to move around within a room or from room to room. An instructor can use equipment that is included on the cart 10 in connection with training personnel with such emergency notification devices.

The emergency notification device cart 10 is designed to be safe, stable, ergonomic, and user friendly. The cart 10 can be any design as appropriate for a portable cart. Preferably, the cart 10 will have a generally horizontal work surface 12 and one or more legs 14 extending downward from the work surface. The legs 14 of the cart preferably include wheels 16 or casters for moving the cart 10 from room to room.

cart 10 can be cast of a relatively heavy material, for example, cast steel, to help to lower the center of gravity of the cart 10 and to provide structural rigidity and stability. The cart 10 can move or preferably be locked on a slope of about 10 degrees to about 15 degrees without tipping. Alternatively, the cart 10 can be made, for example, of a molded or cast polymer, e.g., a polyurethane elastomer. The polymer material can be light and can reduce the total weight of the cart 10. The center of gravity is preferably kept low to provide stability to the cart 10. Other polymers suitable for use in portable carts can be used for the various components of the cart 10. The cart 10 can be in colors having white and off-white tones. Other colors can be chosen.

The emergency notification device cart 10 can be slim and stable. The legs 14 and wheels 16 can be arranged in a square, a rectangle, or other shapes. The cart 10 can be easily maneuvered and can be stable on a variety of floor surfaces. The wheels 16 attached to the legs 14 each can flexibly turn in any desired direction. In some implementations, the wheels 16 are large and sturdy to overcome uneven floors, e.g., cracks, holes, or even stairs, and are of a diameter capable of maneuvering over various terrain, particularly buildings. One or more of the wheels 16 can be locked to resist or stop movement of the cart.

Referring again to FIGS. 1, 2, and 3, a work surface 12 is located, preferably, at a countertop height, e.g., about 2 feet to about 4 feet or about 3 feet above the ground, so that the user can stand or be comfortably seated when operating the emergency notification devices in a training session. The cart 10 can have an adjustable height to allow people of different heights or in different positions, e.g., sitting or standing, to operate the cart 10 comfortably.

Power is supplied to the emergency notification devices by any means appropriate such as a power cord 34 or a battery.

This a portable training device for all facilities that have emergency notification devices installed. This training simulator can be modified according to individual facility needs and is a working example of what happens in case of a real fire in a facility.

The vertical display 11 is outfitted with multiple emergency notification devices which have been modified to react on an as needed basis. The display preferably includes a working pull station 18, bell 24, elevator 26, and strobe light 20. The device may also include a fire door 32 that works by releasing power from a magnet, as is common in many facilities today. This simulates the closing of any fire or smoke door.

In the preferred embodiment, when the fire alarm 18 is activated, the bell 24 goes off and the strobe light 20 flashes, just like in a real fire at a facility, such as a hospital or school.

The display is used to train personnel so that they are aware of what happens in case of a real fire, only with a working visual aide. This prepares the personnel for the sights and sounds that will occur so that they can be prepared to respond properly.

The display 11 with emergency notification devices is custom fit to a rolling cart 10 for easy portability. It may also house a pre-built fire suppression simulator on the bottom.

A 120voltAC/24 vdc electrical circuit with relays powers the devices such that they will operate when the pull station 18 is activated. This is a panel located on the cart with a simple cord to plug in to any 120volt outlet. Some of the emergency notification devices are operated mechanically, such as the elevator and door. These are controlled by magnets but use a cable and weights to close and lower the elevator 26 and the door 32.

The device may also have a simulated gas shut off valve 22 mounted on the front of the display to provide instruction in shutting off the valve in case of emergency or fire. A smoke detector 28 may be mounted on the display. The smoke detector 28 may be operated manually to set off its alarm. This allows for a simulated smoke detector 28 warning for training purposes.

Obviously, many modifications may be made without departing from the basic spirit of the present invention. Accordingly, it will be appreciated by those skilled in the art that within the scope of the appended claims, the invention may be practiced other than has been specifically described herein. Many improvements, modifications, and additions will be apparent to the skilled artisan without departing from the spirit and scope of the present invention as described herein and defined in the following claims.

What is claimed is:

1. A training device, comprising:
a portable display for displaying a plurality of emergency notification devices;
a power supply for providing power to the plurality of emergency notification devices; and
a cart for transporting the portable display for instructional purposes.

2. The device as in claim 1 wherein the emergency notification devices are a plurality selected from the group consisting of a fire alarm, a strobe light, a gas valve, a fire bell, an elevator simulator, a smoke detector, a fire panel and a fire door.

3. The device as in claim 2 wherein the fire alarm controls at least one of the plurality of emergency notification devices.

4. The device as in claim 1 wherein the cart includes a plurality of legs.

5. The device as in claim 4 further comprising a wheel attached to each of the plurality of legs such that the cart may be rolled across a surface.
